(19) United States
(12) Patent Application Publication
(10) Pub. No.: US 2026/0212216 A1
(43) Pub. Date: Jul. 23, 2026

(54) RERANKING RETRIEVED CONTEXT DATA FOR DESIRED INFORMATIONAL CONTEXT

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/034,938

(22) Filed: Jan. 23, 2025

(51) Int. Cl. G06N 5/022

(52) U.S. Cl. CPC G06N 5/022

(57) ABSTRACT

Methods and systems for managing operation of a system are disclosed. Based on a prompt for processing by an inference model, a retrieval process may be performed to obtain a set of chunks of data and a rank ordering from a knowledge data source. The chunks of data may include undesirable information that may include, for example, inconsistent information and/or information that has an entity scope below a threshold level. The chunks may be reranked by identifying entity scopes and/or levels of adherence to identified consistent information content of the chunks for each chunk to obtain a second rank ordering. The second rank ordering may reduce a likelihood that the undesired information is used as context data for obtaining a response using the inference model.

### FIELD

Embodiments disclosed herein relate generally to managing a system. More particularly, embodiments disclosed herein relate to systems and methods to manage operation of a system using inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2D show data flow diagrams in accordance with an embodiment.

FIGS. 3A-3C show flow diagrams illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a system that may provide computer-implemented services. The computer-implemented services may be provided using inference models (e.g., a generative trained machine learning model). The inference models may be used to generate inferences regarding operation of the data processing systems, and the inferences may be used in downstream processes to increase a likelihood of desired operation of the data processing systems. For example, the inference models may be trained to infer information regarding occurrences of security events (e.g., security threats) to the data processing systems based on ingest data, and the operation of the data processing systems may be updated to mitigate (e.g., prevent) negative outcomes associated with the security events.

However, a quality (e.g., reliability) of the inferences used to manage the operation of the data processing systems may depend on a quality (e.g., informational content) of the ingest data provided to the (trained) inference models to obtain the inferences. For example, the ingest data may include a prompt (e.g., input from a downstream consumer of the inferences). If the informational content of the prompt is limited and/or ambiguous, then the ingest data to the inference model may be inadequate for generating an inference of expected quality.

To improve a quality of a generated response, a retrieval-augmented generation process may be implemented. During the retrieval-augmented generation process, context data (e.g., additional information regarding terms such as words and/or phrases in the prompt) may be retrieved from a trusted knowledge base during a retrieval process. The context data may then be used to increase the informational content of the ingest data provided to the inference models to generate the inference. However, due to limitations of the retrieval process, the context data may include undesirable information. For example, the context data may include inconsistent information (e.g., contradictory information), information with an entity scope below a threshold level (e.g., sensitive information regarding an individual entity), and/or any other undesired information.

Thus, to increase a likelihood of providing desired ingest data to the inference models, context data obtained during the retrieval process may be reranked using a set of rules to obtain a second rank ordering. The set of rules may define ranking promotions and/or ranking demotions for each portion of the context data. The set of rules may be based on, for example, an entity scope for each portion of the context data and/or a level of adherence to consistent information described by the context data. By using the context data and the second rank ordering of the context data, the ingest data may be used to obtain a higher quality response (e.g., with respect to accuracy, security, etc.) from the inference models that may be more likely to provide desired computer-implemented services.

In an embodiment, a method for managing operation of a system is provided. The method may include: (i) obtaining, based on a prompt for processing by a trained generative machine-learning model, a set of chunks and a rank ordering for the set of chunks from a knowledge data source; (ii) obtaining a second rank ordering for the set of chunks to reduce a likelihood of undesirable information from the knowledge data source being used as context data for the prompt; (iii) obtaining a response from the generative trained machine-learning model using the prompt, the set of chunks, and the second rank ordering; and (iv) providing computer implemented services using the response.

The undesirable information may be inconsistent information.

The undesirable information may have an entity scope below a threshold level.

Obtaining the second rank ordering may include: (i) identifying an entity scope for each chunk of the set of chunks; and (ii) reranking the set of chunks based on the entity scopes to obtain the second rank ordering.

The set of chunks may also be reranked using a set of rules, the set of rules defining ranking promotions and ranking demotions based on the entity scope for each chunk of the set of chunks.

The ranking promotions may indicate that chunks having group level entity scopes are to be moved up in the second rank ordering when compared to the rank ordering, and the ranking demotions may indicate that chunks having individual level entity scopes are to be moved down in the second rank ordering when compared to the rank ordering.

Obtaining the second rank ordering may include: (i) identifying a chunk of the set of chunks that is highest ranked based on the rank ordering; (ii) identifying portions of information content of the chunk; (iii) for each of the portions of the information content of the chunks, identifying consistent content among the set of the chunks and inconsistent content among the set of chunks; (iv) for each chunk of the set of chunks, identifying a level of adherence to the consistent content identified for each of the portion of the information content of the chunks; and (v) reranking the set of chunks based on the level of adherence for each chunk of the set of chunks to obtain the second rank ordering.

The set of chunks may also be reranked using a set of rules, the set of rules defining ranking promotions and ranking demotions based on the level of adherence of each chunk of the set of chunks.

The ranking promotions may indicate that chunks having higher levels of adherence are to be moved up in the second rank ordering when compared to the rank ordering, and the ranking demotions may indicate that chunks having lower levels of adherence are to be moved down in the second rank ordering when compared to the rank ordering.

The prompt may be based on a behavior of a data processing system, and the response indicates at least one selected from a group consisting of: (i) a root cause for the behavior; (ii) a remediation process to be performed to address the behavior; and (iii) a diagnosis process for the behavior.

A non-transitory media may include instructions that when executed by a processor cause the computer-implemented method to be performed.

A data processing system may include the non-transitory media and a processor, and may perform the computer-implemented method when the computer instructions are executed by the processor.

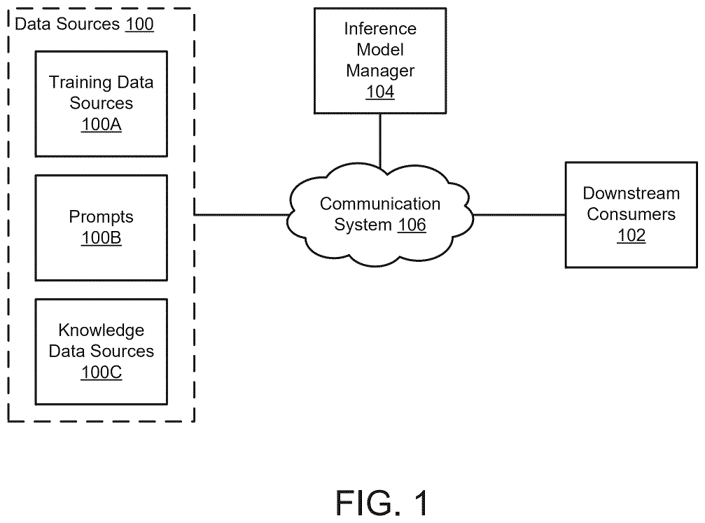

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to consumers of the computer-implemented services (e.g., users of the data processing systems, other data processing systems). To provide the computer-implemented services, operation of the data processing system may be managed using artificial intelligence. For example, (trained) inference models may be used to assess, predict, and/or otherwise manage occurrences of events that may negatively impact provisioning of the computer-implemented services as desired, such as security events that may threaten the security of the data processing system (e.g., sensitive data accessible using the data processing systems).

To do so, an inference model such as a generative machine-learning model may be trained to generate a response to (e.g., an inference based on) ingest data. For example, the ingest data may include a prompt based on a behavior (e.g., an undesired behavior, a security threat, etc.) of a data processing system. The prompt may include, for example, information regarding programs being executed by components of a data processing system, and the inference model may be trained to provide a desired response, based on the ingest data, that indicates a root cause for the behavior of the data processing system, a remediation process to be performed to address the behavior, a diagnosis process for the behavior, and/or any other information. To manage the behavior, the inference may be provided to a downstream process during which operation of the data processing system may be updated in a manner that mitigates an undesired outcome of the undesired behavior.

To increase a likelihood of generating reliable responses during inferencing, a retrieval-augmented generation process may be implemented to improve informational content of the ingest data to the inference models. To do so, the prompt may undergo preprocessing, during which context data may be obtained for terms present in the prompt. The context data may include a set of chunks of data (e.g., documents, data entries in a database, multimedia files, etc.) hosted by a knowledge data source.

To obtain expected quality (e.g., adequate) ingest data, the prompt may be provided to a data pipeline. The data pipeline may include a retrieval process, during which terms in the prompt are identified, and context data for the identified terms is obtained from the knowledge data source. For example, the retrieval process may use methods to (i) identify terms present in the prompt that may require context data, (ii) identify portions of context data from a trusted data source based on the identified terms, (iii) rank the identified portions of context data (e.g., based on relevancy to the terms), and/or (iv) select a number of the ranked identified portions of context data for use as the context data, and/or perform any other actions.

However, due to limitations of these methods, a quality of at least a portion of the context data used for inferencing may be undesirable for obtaining a response usable to effectively manage operation of a data processing system. For example, the chunks of data retrieved from the knowledge data source may include inconsistent information (e.g., contradicting information between at least two chunks of the context data.). Consequently, if the inconsistent information is used as context data, a quality of the inferences and subsequent computer-implemented services provided using the inferences may be negatively impacted. For example, the inferences may be inaccurate, computational resources may be wasted attempting to resolve the inconsistencies, harmful actions may be performed based on the inferences, etc.

Furthermore, the chunks of data retrieved based on the prompt may also include information that has an entity scope below a threshold level. For example, consider a scenario in which a prompt regarding best practices for a network security configuration is obtained for inferencing by an inference model. While retrieving context data for the prompt, at least a portion of chunks of data may include individual level entity scope information, for example, identifiable information regarding a specific network configuration used by a specific data processing system (e.g., internet protocol address, device fingerprints, etc.), personally identifiable information associated with a user of the data processing system, and/or any other undesirable information. If used as context data for inferencing, a response may include information that may be used (e.g., via reverse engineering) to identify the individual entity (e.g., a user, a data processing system, etc.). Consequently, a quality of computer-implemented services provided by the system and using the response may be negatively impacted. For example, the system may be vulnerable to malicious attacks, privacy policy violations, and/or any other adverse effects.

In general, embodiments disclosed herein may provide methods, systems, and/or devices for managing operation of a system using inference models in a manner that is more likely to result in desirable management outcomes. To do so, a prompt for processing by the inference models may be preprocessed using a retrieval process to obtain a set of chunks of data and a rank ordering of the set of chunks from a knowledge source. The set of chunks of data may be reranked using a set of rules (e.g., that promote and/or demote a portion of the chunks based on criteria) to obtain desired context data for inferencing.

To improve a likelihood that undesired information is used as context data for the prompt, a second rank ordering may be obtained for the chunks of data. For example, to obtain the second rank ordering, an entity scope may be identified for each chunk of the set of chunks and the set of chunks may be reranked based on the identified entity scopes. The set of chunks may be reranked, for example, by promoting chunks that have group level entity scopes and demoting chunks that have individual level entity scopes. By doing so, chunks that are below a threshold level (e.g., data that may include identifiable information regarding a single entity) may be less likely to be used as ingest data for inferencing.

The second rank ordering may also be obtained, for example, by identifying a level of adherence to consistent content for the chunks and reranking the set of chunks based on the level of adherence. For example, a first rank ordering of the chunks may be obtained during retrieval from the knowledge data source. The first rank ordering may be based, for example, on relevance of tags associated with chunks of data with respect to the prompt. A highest ranked chunk (based on the first rank ordering) may be identified, and portions of information content of the chunk may also be identified (e.g., via tags associated with the chunk, natural language processing to identify the information content, etc.).

For each of the portions of information content, consistent content and/or inconsistent content may be identified among the set of chunks. For example, to identify the consistent content, similarity scores may be computed for each chunk, a clustering algorithm may be employed to group the set of chunks, and/or any other methods may be implemented. Subsequently, the level of adherence to the identified consistent content may be identified for each chunk of the set of chunks. For example, consider a scenario in which five chunks of data are retrieved based on a prompt regarding provisioning a solid-state drive. Four of the five chunks may describe the solid-state drive with respect to memory devices, and the other one chunk may describe the solid-state drive with respect to a graphics processing unit. It may be identified that the consistent information content relates to memory devices and the inconsistent information content relates to graphics processing units. Therefore, chunks that adhere more to the consistent information may be promoted to be more likely to be used as context data for inferencing based on the prompt, and a quality (e.g., accuracy, stability, etc.) of subsequent responses may be increased.

Thus, by reranking chunks of data based on a set of rules, context data with desired information content may be used to obtain a response from the inference models, thereby increasing a likelihood that the response may provide information usable to manage operation of the system.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

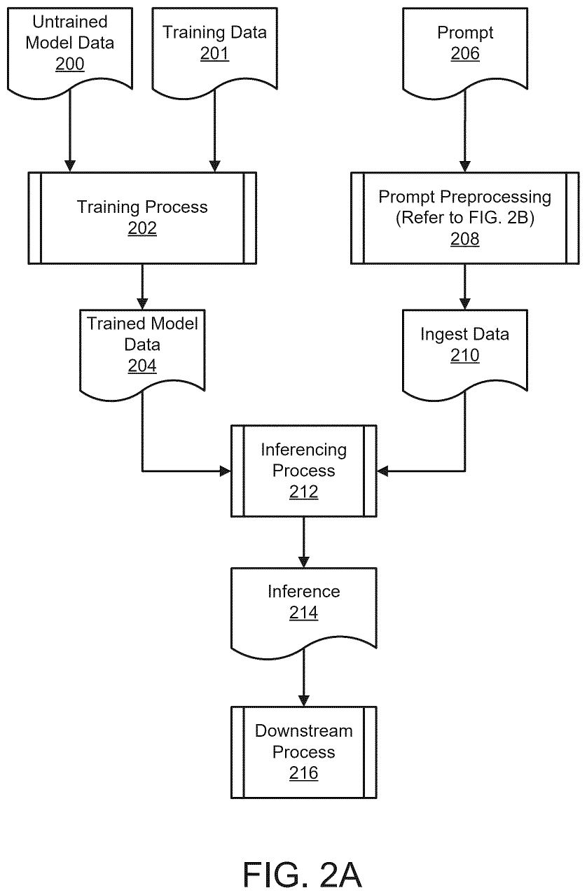

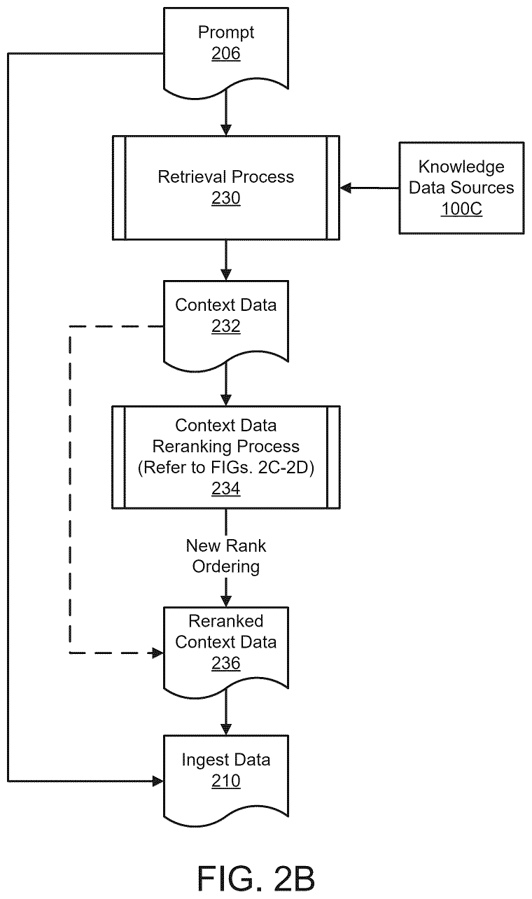

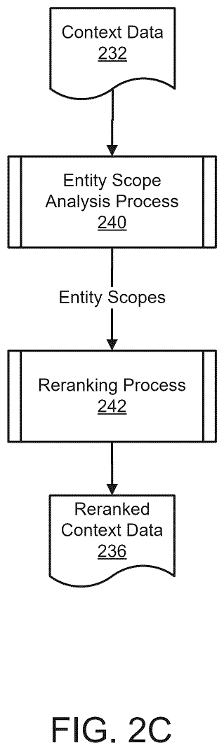

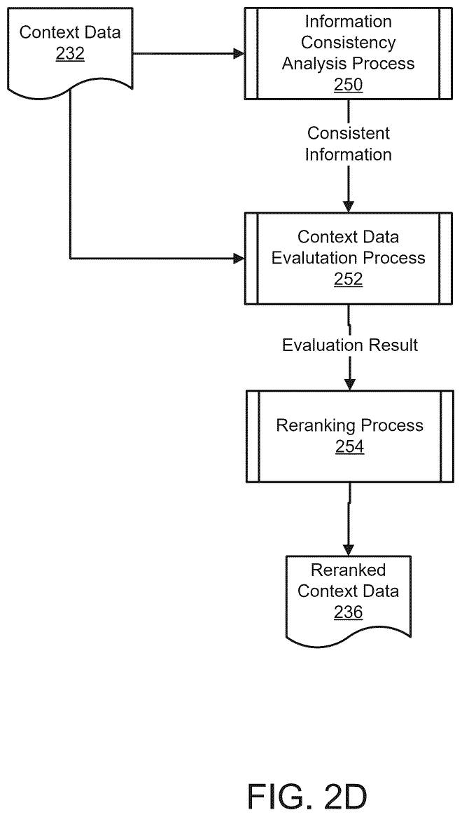

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of terms related to a topic, and may undergo preprocessing to obtain sufficient context data for generating adequate ingest data. Refer to the discussion of FIGS. 2A-2D for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding ontology terms included in ontology definitions defined by the operator and/or an organization of the operator, and may be queried during preprocessing of a prompt of prompts 100B (e.g., during a retrieval process). Because knowledge data sources 100C may host a variety of data that may include undesirable information (e.g., inconsistent information, sensitive information, etc.), context data based on the undesirable information may result in undesirable responses by the inference models. Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models, and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To decrease a likelihood of providing undesirable ingest data to the inference models, inference model manager 104 may (i) obtain a prompt for an inference model (e.g., from prompts 100B), (ii) a retrieval process for the prompt to obtain a set of chunks of data and a rank ordering for the set of chunks of data from knowledge data sources 100C, (iii) rerank the set of chunks of data based on a set of rules to obtain a second rank ordering for the set of chunks of data (iv) obtain ingest data using the set of chunks of data, the second rank ordering and the prompt, and/or perform any other actions. Refer to the discussion of FIG. 2B for more details regarding classification of the retrieved context data.

For example, to obtain the second rank ordering, inference model manager 104 may identify a quality of each chunk of the set of chunks, rerank the set of chunks based on the quality and using a set of rules, and/or perform any other actions. Identifying the quality may include, for example, (i) identifying an entity scope for each chunk of the set of chunks, and/or (ii) identifying consistent information content among the set of chunks and a level of adherence to the consistent information content for each chunk. To do so, inference model manager 104 may extract information content from the chunks, analyze tags associated with the chunks, process the chunks using a large language model, compute scores (e.g., similarity scores) for the chunks, and/or perform any other actions.

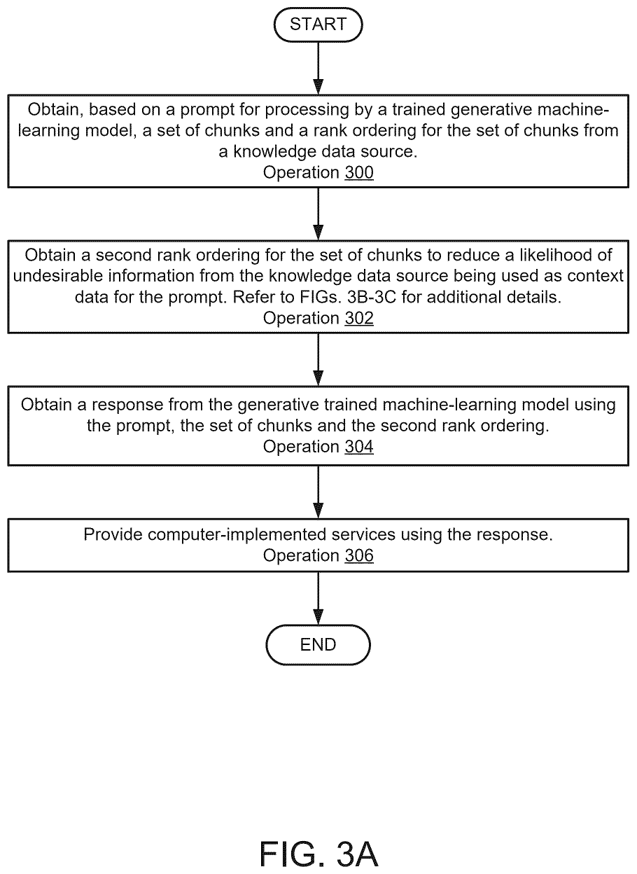

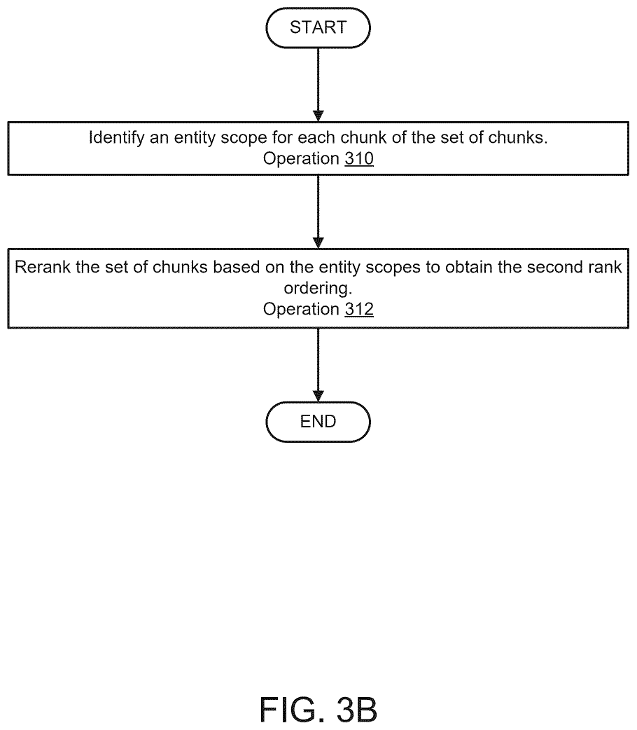

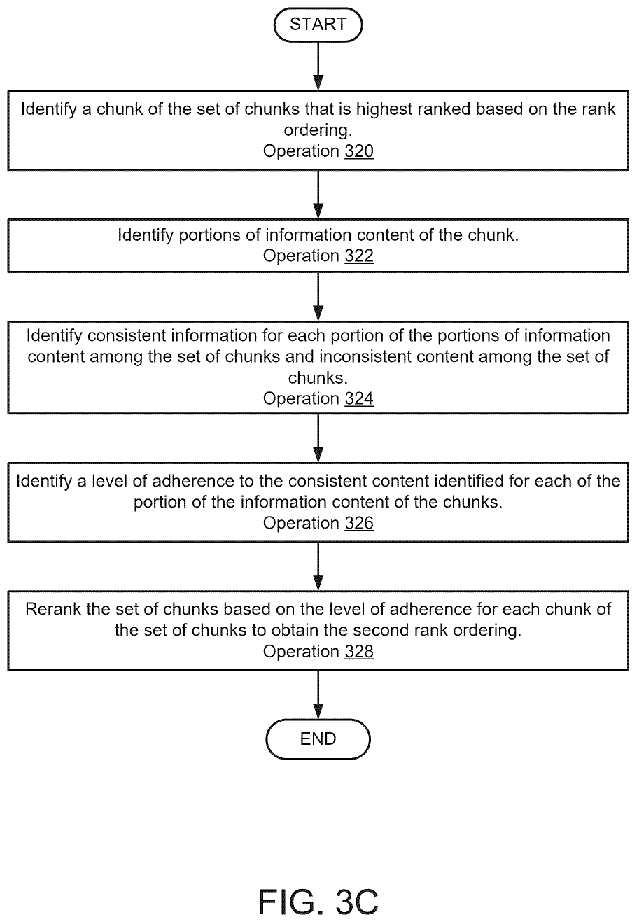

When providing their functionality, any of data sources 100, downstream consumers 102, inference model manager 104, and/or components thereof may perform all, or a portion of the actions and methods illustrated in FIGS. 2A-3C.

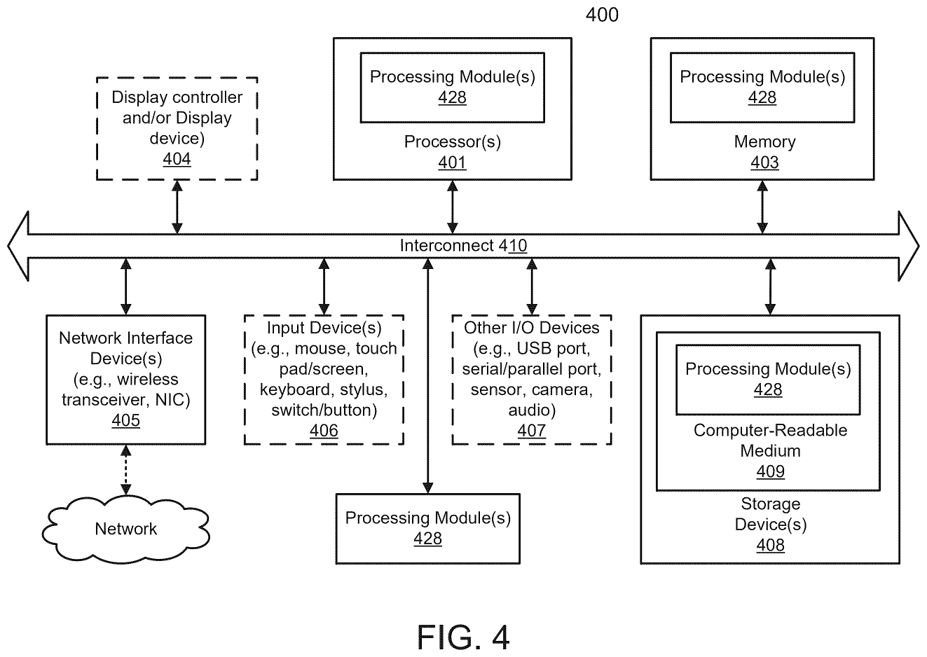

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2D. In the diagram, flows of data and processing of data are illustrated using different sets of shapes. A first set of shapes (e.g., 200, 201) is used to represent data structures, a second set of shapes (e.g., 202, 208) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to obtain responses usable to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210.

Ingest data 210 may include a portion of data for which an inference is desired to be obtained. For example, ingest data 210 may include prompt 206 (e.g., of prompts 100B). Prompt 206 may be obtained, for example, from a consumer of inferences and may indicate that a response is desired. To obtain ingest data 210 (e.g., an enhanced version of prompt 206), prompt 206 may undergo prompt preprocessing 208. For example, during prompt preprocessing 208, chunks of data may be retrieved relevant to prompt 206, qualities (e.g., entity scope, consistency, etc.) of each chunk of the chunks may be identified, the chunks of data may be reranked based on the identified qualities, the reranked chunks of data may be used as context data, and ingest data 210 may be generated based on prompt 206 and the context data. Refer to the discussion of FIGS. 2B-2D for more details regarding prompt preprocessing and obtaining ingest data 210.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference). To do so, each ingest data set of ingest data 210 may be separately submitted to the trained inference model.

For example, ingest data 210 may include information regarding data loss observed for a data processing system. Based on ingest data 210, inference 214 may be obtained that may indicate a root cause for the data loss, a diagnosis process for the data loss, and/or a remediation process to be performed to prevent further data loss and/or recover lost data. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214 (e.g., initiating performance of actions indicated by inference 214).

To provision the computer-implemented services, downstream process 220 may be performed. During downstream process 220, the response may be provided to a downstream consumer, and operation of the data processing system may be updated using the response. The response may be provided to the downstream consumer, for example, by presenting the response via a user interface viewable by the downstream consumer. Operation of the data processing system may be updated directly based on the response (e.g., using a decision-making policy), and/or initiated by the downstream consumer as a result of consuming the response. For example, downstream process 220 may include a policy enforcement process, wherein security policies for the data processing system are enforced based on information indicated by the response (e.g., actions, security and/or configuration settings) in order to mitigate outcomes associated with the data loss. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flows shown in FIG. 2A, operation of a system may be managed using a response obtained using a trained inference model. By doing so, operation of the system may be more likely to be updated in a manner that may provide desired computer-implemented services.

Turning to FIG. 2B, a second data flow diagram in accordance with an embodiment is shown. The second data flow diagram may illustrate data used in and data processing performed during obtaining of ingest data that may include desired information for an inference model. FIG. 2B may be an example of prompt preprocessing 208 of FIG. 2A.

To obtain the ingest data, context data for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system, a request for second information (e.g., a question), and/or any other information.

To obtain the context data for prompt 206, retrieval process 230 may be performed. Retrieval process 230 may include any type of process(es) wherein information (e.g., terms) present in a prompt is identified, and additional information is retrieved from a data source based on the identified information. For example, retrieval process 230 may implement information retrieval methods used during a type of retrieval-augmented generation process. During retrieval process 230, a prompt (e.g., prompt 206) may be obtained and used to generate a query (e.g., a keyword search query). The query may include, for example, search terms, search parameters, and/or other information. The query may then be used to search an external data source such as knowledge data sources 100C to identify responsive portions of data stored by the external data source.

As discussed with respect to FIG. 1, knowledge data sources 100C may include a data source designated as a source of true (e.g., trusted, reliable, relevant to a subject area) data by an operator of the inference model. For example, knowledge data sources 100C may include any number of chunks of data that are tagged to associate each of the number of chunks of data with ontology terms (and/or other searchable terms).

As a result of retrieval process 230, context data 232 may be obtained that may include at least a portion of the chunks of data (e.g., that may be deemed relevant to the prompt) and/or a first rank ordering for the chunks of data. The first rank ordering may be based on, for example, a ranking algorithm during retrieval process 230. Because the chunks of data may include undesirable information (e.g., contradicting information, personally identifiable information, etc.), a new rank ordering may be obtained to reduce a likelihood that the undesirable information may be used as context data for ingest data 210.

To obtain the new rank ordering for the chunks, context data reranking process 234 may be performed. During context data reranking process 234, at least one quality of each chunk of the chunks of data may be analyzed, and the chunks may be reranked based on the at least one quality. For example, an entity scope may be identified for each chunk, and the chunks may be reranked based on the identified entity scopes. Refer to FIG. 2C for additional details regarding reranking the chunks of data based on an identified entity scope to obtain reranked context data 236.

Furthermore, consistent information content may be identified among the set of chunks. For each chunk, a level of adherence to the consistent information content may subsequently be identified, and the chunks may be reranked based on the level of adherence to the consistent information content. For example, the consistent information may be identified based on similarity to information content identified for a highest ranked chunk of data (e.g., based on a first rank ordering obtained during retrieval process 230), a frequency of occurrences of a portion of information among the chunks of data, and/or any other methods. Refer to FIG. 2D for additional details regarding reranking the chunks of data based on a level of adherence to consistent information to obtain reranked context data 236.

Reranked context data 236 may be based on the chunks of data and the new rank ordering. For example, reranked context data 236 may include all chunks of data retrieved during retrieval process 230 (e.g., data flow shown in a long-dashed line) that may be ordered in a manner such that more desirable portions (e.g., based on the entity scope, level of adherence to consistent information, etc.) of the chunks of data are weighed more heavily compared to less desirable portions of the chunks of data (e.g., and are thereby more likely to be used as context data for inferencing), a filtered portion of the chunks of data based on criteria (e.g., a threshold for the entity scope, level of adherence, and/or any other metrics), and/or any other information.

Once obtained, reranked context data 236 may be used to obtain input data for the trained inference model (as discussed in FIG. 2A). To do so, a copy of prompt 206 may be added ingest data 210 along with a reranked context data 236 (as shown in the data flow).

Thus, using the data flows shown in FIG. 2B, chunks of data obtained during a retrieval process for on a prompt may be reranked based on an identified quality of each chunk of the chunks of data. By doing so, a likelihood that desirable context data may be used and/or undesirable context data may be prevented from being used as ingest data during generation of a response to the prompt may be improved.

Turning to FIG. 2C, a third data flow diagram in accordance with an embodiment is shown. The third data flow diagram may illustrate data used in and data processing performed during obtaining of reranked context data based on entity scopes of retrieved chunks of data. FIG. 2C may be an example of context data reranking process 234 of FIG. 2B.

As previously discussed in FIG. 2B, context data 232 may include chunks of data and a first rank ordering for the chunks of data obtained during retrieval process 230. Because context data 232 may include information that has an entity scope below a threshold level, a response generated by an inference model based on ingest data that includes the information (e.g., below the threshold level) may be undesirable.

For example, consider a scenario in which chunks of data are retrieved from the knowledge data source based on a prompt pertaining to economics of a company. The chunks may include public financial reports, news articles, employee wage data, and/or any other information. An operator of the inference models (e.g., inference model manager 104) may define a privacy policy that limits data access to entities (e.g., users that may submit a prompt for processing by the inference models). For example, a user may not have required privilege to access sensitive information based on a user profile of the user. If used as ingest data for inference, the sensitive information (e.g., wage data for a specific employee) may be obtained, at least indirectly (e.g., provided in the response, reverse engineered by a malicious entity, etc.), by the user.

To reduce a likelihood that the information below a threshold level is used as ingest data, entity scope analysis process 240 may be performed. During entity scope analysis process 240, an entity scope for each chunk of data of context data 232 may be identified. For example, each chunk may be evaluated (e.g., using natural language processing) to identify a quantity of entities mentioned in a chunk, a granularity (e.g., group, individual, etc.) of the entities mentioned in the chunk, and/or any other information related to an entity scope of the chunk.

Additionally, a quality (e.g., derivability, relevance, etc.) of the identified entities of each chunk may be evaluated with respect to an identified primary entity based on the prompt, a highest ranked chunk, and/or criteria. For example, it may be identified that a portion of the chunks may introduce new entities that may be derivatives of the identified primary entity (e.g., as a result of illustrative examples and/or peripheral discussion relevant to the primary entity). The new entities may impact the entity scope, and the entity scope of the portion of the chunks may subsequently be adjusted based on the quality of the identified entities.

Once identified, the entity scopes may be used to obtain a second rank ordering for the chunks. To do so, reranking process 242 may be performed. During reranking process 242, the chunks may be reranked based on the entity scopes. For example, the chunks may be reranked using a set of rules that define ranking promotions and ranking demotions based on the entity scope for each chunk. The ranking promotions may indicate, for example, that chunks having group level entity scopes (e.g., describing a number of entities above the entity scope threshold level) are to be moved up in the second rank ordering when compared to first rank ordering, and the rank demotions may indicate that chunks having individual level entity scopes (e.g., describing a number of entities below the entity scope threshold level) are to be moved down in the second rank ordering.

Reranked context data 236 may include the second rank ordering obtained during reranking process 242, at least a portion of context data 232 ordered according to the second rank ordering, and/or any other information. For example, reranked context data 236 may include a filtered portion of context data 232 based on the identified entity scopes and the threshold level.

By doing so, the chunks of data that include the information that have entity scopes below the threshold level may be less likely to be used during inferencing and/or be included, at least indirectly, in a response.

Turning to FIG. 2D, a fourth data flow diagram in accordance with an embodiment is shown. The fourth data flow diagram may illustrate data used in and data processing performed during obtaining of reranked context data based on levels of adherence to consistent information of retrieved chunks of data. FIG. 2D may be an example of context data reranking process 234 of FIG. 2B.

As previously discussed in FIG. 2B, context data 232 may include chunks of data and a first rank ordering for the chunks of data obtained during retrieval process 230. Because context data 232 may include information that has is inconsistent, a response generated by an inference model based on ingest data that includes the inconsistent information may be undesirable.

For example, consider a scenario in which chunks of data are retrieved from the knowledge data source based on a prompt pertaining to overheating experienced by a data processing system. The chunks may include technical documents, hardware manuals, device specifications, and/or any other type of information. A first portion of the chunks (e.g., 10 chunks) may describe cooling system efficiency of data processing systems. A second portion of the chunks (e.g., 1 chunk) may describe desktop background images. If used as ingest data for inferencing, undesired responses may be obtained (e.g., contradicting information, information that may not be relevant, etc.).

To reduce a likelihood that inconsistent information is used as ingest data, information consistency analysis process 250 may be performed. During information consistency analysis process 250, consistent information and/or inconsistent information may be identified. For example, to identify the consistent and/or inconsistent information, a highest ranked chunk may be identified based on the first rank ordering (e.g., obtained during retrieval process 230). Portions of information content of the chunk may be identified. For example, tags associated with the chunk may be identified, the chunk may be evaluated using natural language processing, and/or via any other methods. For each of the portions of information content of the chunks, the consistent information may be identified, for example, by identifying similarity of the information content compared to the information content of the highest ranked chunk, identifying a frequency of occurrences of information content among the chunks, and/or via any other processes.

Once identified, the chunks of data that include the consistent information and/or the chunks of data that include the inconsistent information may be identified. To do so, context data evaluation process 252 may be performed. During context data evaluation process 252, a level of adherence to the consistent information content may be identified for each chunk. For example, to identify the level of adherence, information content of a chunk of data may be compared to the consistent information. Returning to the example of the overheating experienced by the data processing system, the portion of chunks that describe desktop background images may be evaluated to have a lower level of adherence (e.g., a similarity score) to consistent information compared to the portion of chunks that describe cooling systems.

Once identified, the levels of adherence may be used to obtain a second rank ordering for the chunks. To do so, reranking process 254 may be performed. During reranking process 254, the chunks may be reranked based on the levels of adherence. For example, the chunks may be reranked using a set of rules that define ranking promotions and ranking demotions based on the levels of adherence for each chunk. The ranking promotions may indicate, for example, that chunks having higher levels of adherence (e.g., including information content more similar to the identified consistent information) are to be moved up in the second rank ordering when compared to first rank ordering, and the rank demotions may indicate that chunks having lower levels of adherence (e.g., including information content less similar to the identified consistent information) are to be moved down in the second rank ordering.

Reranked context data 236 may include the second rank ordering obtained during reranking process 245, at least a portion of context data 232 ordered according to the second rank ordering, and/or any other information. For example, reranked context data 236 may include a filtered portion of context data 232 based on the identified levels of adherence.

By doing so, the chunks of data that include information content that contradicts identified consistent information may be less likely to be used during inferencing and/or be included, at least indirectly, in a response.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 3A, a first flow diagram illustrating a method in accordance with an embodiment is shown. The flow diagram may illustrate various operations performed while managing operation of a system.

At operation 300, a set of chunks and a rank ordering for the set of chunks may be obtained from a knowledge data source based on a prompt for processing by a trained generative machine-learning model. The set of chunks and the rank ordering may be obtained by: (i) deriving a query based on the prompt, (ii) encoding the query using a pretrained embedding model, (iii) searching a knowledge based using a retrieval system (e.g., dense retrieval, sparse retrieval, etc.), (iv) performing a first ranking process using a ranking algorithm to rank the chunks of the set of chunks, and/or performing any other actions.

At operation 302, a second rank ordering for the set of chunks may be obtained to reduce a likelihood of undesirable information from the knowledge data sources being used as context data for the prompt. The second rank order may be obtained by: (i) identifying an entity scope for each chunk, (ii) identifying consistent information content among the set of chunks, (iii) identifying a level of adhere to the consistent information for portions of information content of the chunks, (iv) reranking the set of chunks based on the entity scope and/or the levels of adherence, and/or performing any other actions. Refer to FIGS. 3B-3C for additional details regarding obtaining the second rank ordering.

At operation 304, a response from the generative trained machine-learning model may be obtained. The response may be obtained by (i) receiving the response (e.g., from another device), (ii) reading the response (e.g., from storage), and/or (iii) generating the response. The response may be generated using methods described with respect to FIG. 2A and/or by other methods. For example, the response may be obtained by (i) obtaining (e.g., training) the trained generative machine-learning model, (ii) obtaining (e.g., generating) ingest data based on the prompt, the chunks of data, and the second rank ordering, (iii) submitting the ingest data to the trained generative machine-learning model for processing.

The response may indicate, for example, (i) a root cause for behavior of a data processing system described in the prompt, (ii) a remediation process to be performed to address the behavior, (iii) a diagnosis process for the behavior, and/or any other information.

At operation 306, computer-implemented services may be provided using the response. The computer-implemented services may be provided by: (i) providing the response to a downstream consumer as a first portion of the desired computer-implemented services, (ii) providing the response to a downstream process to obtain an output from the downstream process, and/or (iii) using the output from the downstream process to provision a second portion of the desired computer-implemented services.

The method may end following operation 306.

Using the method shown in FIG. 3A, chunks of data retrieved based on a prompt may be reranked to provide desired informational context for processing by an inference model. By doing so, a response may be obtained that be used by the system to provide improved computer-implemented services.

Turning to FIG. 3B, a second flow diagram illustrating a method in accordance with an embodiment is shown. The flow diagram may illustrate various operations performed while obtaining a second rank ordering for a set of chunks of data based on entity scopes of the chunks.

At operation 310, an entity scope may be identified for each chunk of the set of chunks. The entity scope may be identified by: (i) identifying tags associated with the chunks, (ii) referencing a stored data source that defines entity scopes for the chunks for data, (iii) performing natural language processing to identify the entity scope for the chunks, (iv) computing a cumulative number of entities that the chunks describe, and/or performing any other actions.

At operation 312, the set of chunks may be reranked based on the entity scopes to obtain the second rank ordering. The set of chunks may be reranked by: (i) applying a set of rules to assign priority to chunks of data with an entity scope below a threshold level, (ii) promoting chunks that have a group level entity scope, (iii) demoting chunks that have an individual level entity scope, (iv) filtering to remove chunks below the threshold level, and/or performing any other actions.

The method may end following operation 312.

Using the method shown in FIG. 3B, chunks of data that have an entity scope below a threshold level may be less likely to be used as context data for the prompt. By doing so, a response generated using the context data may be more likely to provide desired computer-implemented services.

Turning to FIG. 3C, a third flow diagram illustrating a method in accordance with an embodiment is shown. The flow diagram may illustrate various operations performed while obtaining a second rank ordering for a set of chunks of data based on levels of adherence to consistent information of the chunks.

At operation 320, a chunk that is highest ranked based on the first rank ordering may be identified. The highest ranked chunk may be identified by: (i) selecting the top hit chunk returned during the retrieval process, (ii) selecting a random portion that may be within an acceptable range of relevancy scores, and/or performing any other actions.

At operation 322, portions of information content of the chunk may be identified. The portions of information content may be identified by: (i) identifying tags associated with the portion of context data, (ii) extracting information from the content of the portion of context data (e.g., using natural language processing), (iii) prompting an inference model, and/or via any other processes.

At operation 324, consistent information may be identified for each portion of the portions of information content may be identified. The consistent information may be identified by: (i) scoring the information content of other chunks with respect to similarity to information content of the highest ranked chunk, (ii) a clustering algorithm (e.g., partition-based clustering, density-based clustering, etc.) on the information content of the chunks, (iii) computing a frequency of occurrences of the information content among the set of chunks, and/or performing any other actions.

At operation 326, a level of adherence to the consistent content may be identified for each of the portion of information content of the chunks. The level of adherence may be identified by: (i) computing a similarity score between the information content of each chunk to the consistent information, (ii) computing a ratio between information content of each chunk that includes consistent information and information content that includes inconsistent information, and/or via any other processes.

At operation 328, the set of chunks may be reranked based on the levels of adherence to obtain the second rank ordering. The set of chunks may be reranked by: (i) applying a set of rules to assign more weight to chunks of data with higher levels of adherence, (ii) promoting chunks that have a higher level of adherence, (iii) demoting chunks that have a lower level of adherence, (iv) filtering to remove chunks that below a threshold level of adherence, and/or performing any other actions.

The method may end following operation 328.

Using the method shown in FIG. 3C, chunks of data that include inconsistent information may be less likely to be used as context data for the prompt. By doing so, a response generated using the context data may be more likely to provide desired computer-implemented services.

Thus, as illustrated above, embodiments disclosed herein may provide systems and methods for managing context data retrieval for inference models used to manage operation of a data processing system. By obtaining a second rank ordering for the retrieved context data, desired information may be more likely to be used as context data for inferencing. As a result, a response may be obtained that may be more likely to effectively manage operation of a system to provide desired computer-implemented services (e.g., that may be of a higher quality and/or level of security).

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a system, the method comprising:
obtaining, based on a prompt for processing by a trained generative machine-learning model, a set of chunks and a rank ordering for the set of chunks from a knowledge data source;
obtaining a second rank ordering for the set of chunks to reduce a likelihood of undesirable information from the knowledge data source being used as context data for the prompt;
obtaining a response from the generative trained machine-learning model using the prompt, the set of chunks, and the second rank ordering; and
providing computer implemented services using the response.

2. The method of claim 1, wherein the undesirable information is inconsistent information.

3. The method of claim 1, wherein the undesirable information has an entity scope below a threshold level.

4. The method of claim 1, wherein obtaining the second rank ordering comprises:
identifying an entity scope for each chunk of the set of chunks; and
reranking the set of chunks based on the entity scopes to obtain the second rank ordering.

5. The method of claim 4, wherein the set of chunks are also reranked using a set of rules, the set of rules defining ranking promotions and ranking demotions based on the entity scope for each chunk of the set of chunks.

6. The method of claim 5, wherein the ranking promotions indicate that chunks having group level entity scopes are to be moved up in the second rank ordering when compared to the rank ordering, and the ranking demotions indicate that chunks having individual level entity scopes are to be moved down in the second rank ordering when compared to the rank ordering.

7. The method of claim 1, wherein obtaining the second rank ordering comprises:
identifying a chunk of the set of chunks that is highest ranked based on the rank ordering;
identifying portions of information content of the chunk;
for each of the portions of the information content of the chunks, identifying consistent content among the set of the chunks and inconsistent content among the set of chunks;
for each chunk of the set of chunks, identifying a level of adherence to the consistent content identified for each of the portion of the information content of the chunks; and
reranking the set of chunks based on the level of adherence for each chunk of the set of chunks to obtain the second rank ordering.

8. The method of claim 7, wherein the set of chunks are also reranked using a set of rules, the set of rules defining ranking promotions and ranking demotions based on the level of adherence of each chunk of the set of chunks.

9. The method of claim 8, wherein the ranking promotions indicate that chunks having higher levels of adherence are to be moved up in the second rank ordering when compared to the rank ordering, and the ranking demotions indicate that chunks having lower levels of adherence are to be moved down in the second rank ordering when compared to the rank ordering.

10. The method of claim 1, wherein the prompt is based on a behavior of a data processing system, and the response indicates at least one selected from a group consisting of:
a root cause for the behavior;
a remediation process to be performed to address the behavior; and
a diagnosis process for the behavior.

11. A non-transitory machine-readable medium having instructions stored therein, which when executed by a processor, cause the processor to perform operations for managing operation of a system, the operations comprising:
obtaining, based on a prompt for processing by a trained generative machine-learning model, a set of chunks and a rank ordering for the set of chunks from a knowledge data source;
obtaining a second rank ordering for the set of chunks to reduce a likelihood of undesirable information from the knowledge data source being used as context data for the prompt;
obtaining a response from the generative trained machine-learning model using the prompt, the set of chunks, and the second rank ordering; and
providing computer implemented services using the response.

12. The non-transitory machine-readable medium of claim 11, wherein the undesirable information is inconsistent information.

13. The non-transitory machine-readable medium of claim 11, wherein the undesirable information has an entity scope below a threshold level.

14. The non-transitory machine-readable medium of claim 11, wherein obtaining the second rank ordering comprises:
identifying an entity scope for each chunk of the set of chunks; and
reranking the set of chunks based on the entity scopes to obtain the second rank ordering.

15. The non-transitory machine-readable medium of claim 11, wherein obtaining the second rank ordering comprises:
identifying a chunk of the set of chunks that is highest ranked based on the rank ordering;
identifying portions of information content of the chunk;
for each of the portions of the information content of the chunks, identifying consistent content among the set of the chunks and inconsistent content among the set of chunks;
for each chunk of the set of chunks, identifying a level of adherence to the consistent content identified for each of the portion of the information content of the chunks; and
reranking the set of chunks based on the level of adherence for each chunk of the set of chunks to obtain the second rank ordering.

16. A data processing system, comprising:
a processor; and
a memory coupled to the processor to store instructions, which when executed by the processor, cause operations for managing operation of a system to be performed, the operations comprising:
obtaining, based on a prompt for processing by a trained generative machine-learning model, a set of chunks and a rank ordering for the set of chunks from a knowledge data source;
obtaining a second rank ordering for the set of chunks to reduce a likelihood of undesirable information from the knowledge data source being used as context data for the prompt;
obtaining a response from the generative trained machine-learning model using the prompt, the set of chunks, and the second rank ordering; and
providing computer implemented services using the response.

17. The data processing system of claim 16, wherein the undesirable information is inconsistent information.

18. The data processing system of claim 16, wherein the undesirable information has an entity scope below a threshold level.

19. The data processing system of claim 16, wherein obtaining the second rank ordering comprises:
identifying an entity scope for each chunk of the set of chunks; and
reranking the set of chunks based on the entity scopes to obtain the second rank ordering.

20. The data processing system of claim 16, wherein obtaining the second rank ordering comprises:
identifying a chunk of the set of chunks that is highest ranked based on the rank ordering;
identifying portions of information content of the chunk;
for each of the portions of the information content of the chunks, identifying consistent content among the set of the chunks and inconsistent content among the set of chunks;
for each chunk of the set of chunks, identifying a level of adherence to the consistent content identified for each of the portion of the information content of the chunks; and
reranking the set of chunks based on the level of adherence for each chunk of the set of chunks to obtain the second rank ordering.
